(19) United States
(12) Patent Application Publication
(10) Pub. No.: US 2008/0235214 A1
(43) Pub. Date: Sep. 25, 2008

(54) System and method for event search

(76) Inventors: Sten Nikolai Sandberg, Husoystrand (NO); Ole Anders Sorli, Oslo (NO); Knut Tangen, Kongsberg (NO)

Correspondence Address: WENDEROTH, LIND & PONACK, L.L.P., 2033 K STREET N. W., SUITE 800, WASHINGTON, DC, 20006-1021, US

(21) Appl. No.: 12/007,860

(22) Filed: Jan. 16, 2008

Related U.S. Application Data
(60) Provisional application No. 60/880,449, filed on Jan. 16, 2007.

(51) Int. Cl. G06F 17/30; G06F 3/048

(52) U.S. Cl. 707/5; 715/760; 707/E17.108

(57) ABSTRACT

The present invention discloses a system that provides for online search of events using electronic devices where the system comprises, a portal page, a poster tree structure, and a search engine configured to search events using what functionality, where functionality and when functionality. Further it is disclosed a method that provides online search of events using electronic devices where the method comprises the step of; opening a portal page configured to search events, moving a pointer or cursor to a what main category, optionally moving the cursor or pointer to a what sub-category, choosing a what main category or what sub-category moving the cursor or pointer to a where field, choosing a geographical area of interest, and moving the cursor or pointer to a when field and choosing an event date.

### RELATED APPLICATION

The present application claims priority under 35 U.S.C. § 119 to U.S. provisional application No. 60/880,449 filed Jan. 16, 2007. The entire teachings of said application are incorporated herein by reference.

### TECHNICAL FIELD

The present application relates to a system and a method for searching events using electronic devices such as computers, PDA's, cell phones etc. In particular it relates to a system and a search method having a “What, where and when” hierarchical method for categorizing events that renders only hits that are particularly relevant in a “what” context.

### BACKGROUND ART

There are numerous search engines and search tools that are accessible using Internet, some of these search tools are directed against events, such as sports and cultural events. Many newspapers and ticket vendors' offers search tools on Internet giving consumers of sport and/or culture events a possibility to screen through a choice of offers. These services are usually sponsored by advertiser which pays for advertisements on these sites.

The principle of services paid by advertisers results in a lot of hits that are not relevant for the consumer, due to the fact that some advertisers may have paid extra to have their advertisements pop up almost “everywhere”. Another reason for bad hitting accuracy is that event vendors and advertisers may add keyword that are not relevant for a particular event but which is expected to render a lot of hits, hence giving their particular advertisement many hits.

Seen from a consumer perspective the lack of preciseness relative to search criterions are frustrating, and will often lead to a lot of extra search effort.

Seen from an event providers perspective the lack of preciseness is also frustrating and may particularly for event providers providing events of a narrow character result in either that they don't use such channels for advertising or that their adverts are drowned by advertisements from advertisers that have paid extra for a lot of exposure.

The lack of preciseness also implies that most advertisers today have unnecessary high costs, paying for their ads to be exposed to a great number of consumers, who are not at all interested in their products.

In the long run providers of search facilities that lack preciseness will lead to lack of interest from consumers and thereby by advertisers. And after a while they will not be updated by an adequate number of event providers.

As of today there is no directly targeted ads solution (in picture form) on the net or in other media. Existing concepts in the TV and Cable TV areas are also lacking quite a bit to live up to expectations from advertisers, event providers or consumers.

Google's AdSense has a function (text only), but unfortunately also makes possible a misrepresentation from the advertisers side, with regards to the stated interests of the user. This system is heavily based on keyword provided by advertisers.

Hence there is a need for a system and a method for event search that are precise and reliable.

### DISCLOSURE OF THE INVENTION

The present invention provides a system and method that addresses the problems described above in that it provides a system for online search of events using electronic devices where the system comprises, a portal page, a poster tree structure, and a search engine configured to search events using what functionality, where functionality and when functionality.

Further according to the invention it is disclosed a method that provides online search of events using electronic devices where the method comprises the step of;
opening a portal page configured to search events,
moving a pointer or cursor to a what main category,
optionally moving the cursor or pointer to a what sub-category, choosing a what main category or what sub-category
moving the cursor or pointer to a where field, choosing a geographical area of interest, and
moving the cursor or pointer to a when field and choosing an event date.

Other advantageous features will be apparent from the accompanying dependent claims.

### BRIEF DESCRIPTION OF THE DRAWINGS

In order to make the invention more readily understandable, the discussion that follows will refer to the accompanying drawings, in which;

FIG. 1 shows roles according to the present invention,

FIG. 2 shows an overview of events as displayed for event organizers'/organizer users

FIG. 3 shows an example of a poster tree structure according to the present invention,

FIG. 4 shows an example of an overview of arenas,

FIG. 5 shows an example of a report provided to franchisees' and call center users,

FIG. 6 shows an example of an overview of users according to the present invention,

FIG. 7 shows an example of an entry page of a portal according to the present invention,

FIG. 8 shows an example of a first view of the portal after posters have been downloaded and before a user has started a search,

FIG. 9 shows an example of a view of the portal after a user has activated the “What” menu,

FIG. 10 shows another example of a view of the portal after a user has activated the “What” menu,

FIG. 11 shows an example of a view of the portal after a user has activated the “Where” menu, and

FIG. 12 shows an example of a view of the portal displaying final search results.

### MODE(S) FOR CARRYING OUT THE INVENTION

In the following a detailed description of the invention will be discussed by describing modes for carrying out the invention, and by referring to the accompanying drawings. However, even if specific embodiments and modes for carrying out the invention are described, people skilled in the art will realize other applications and modifications within the scope of the invention as defined in the enclosed independent claims.

The present invention comprises a search facility facilitating search for events such as cultural and/or sport events, the search facility is accessed on a portal using computers, PDA's or cell phones. The portal may be accessed by consumers or by event providers. In the following the wording users shall be interpreted as consumers if nothing else is explicitly indicated or obvious from the context.

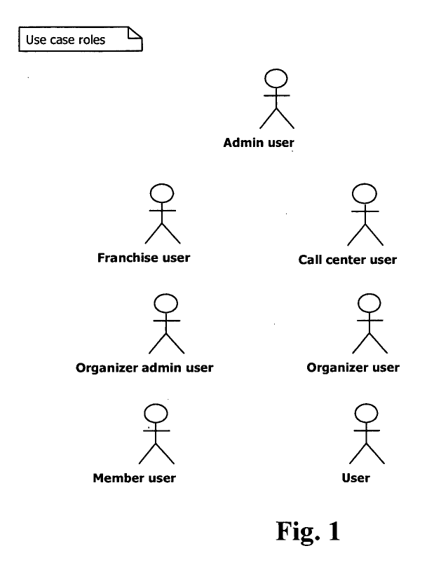

The system according to the present invention facilitates access by a number of users and/or user groups, from consumers to users having administrative rights. The different categories of users can be divided into roles, where the following roles may apply (FIG. 1):
Admin user, is a user which may logon with administrators access rights to the system, hence having few or none restrictions. This type of role is dedicated to system operators.
Franchise user, is a user which is allowed access to all events, arenas and organizers within the same country, he is allowed to make changes to all events, arenas and organizers. Each franchise district will have its dedicated role.
Call center users, similar to franchise users.
Organizer users (event organizers'), only have access to the organizers own registered events. This user can modify, delete or create new events. This group of users is dealt with in a particular way within the system and they are provided with a user interface that is different than other users.
Member user, is a user which has registered and which have access to “my area” (min arena) he/she have all other rights given to “user”.
User has the right to search for events, order tickets and has read access rights. “User” doesn't need to register.

In the following some of the roles will be discussed in more detail.

### Organizer Users (Event Organizers')

After having logged onto the system the organizer will access a portal named “Green Room”, in this “room” all necessary links are provided. Furthermore user guides for the Organizers' are provided.

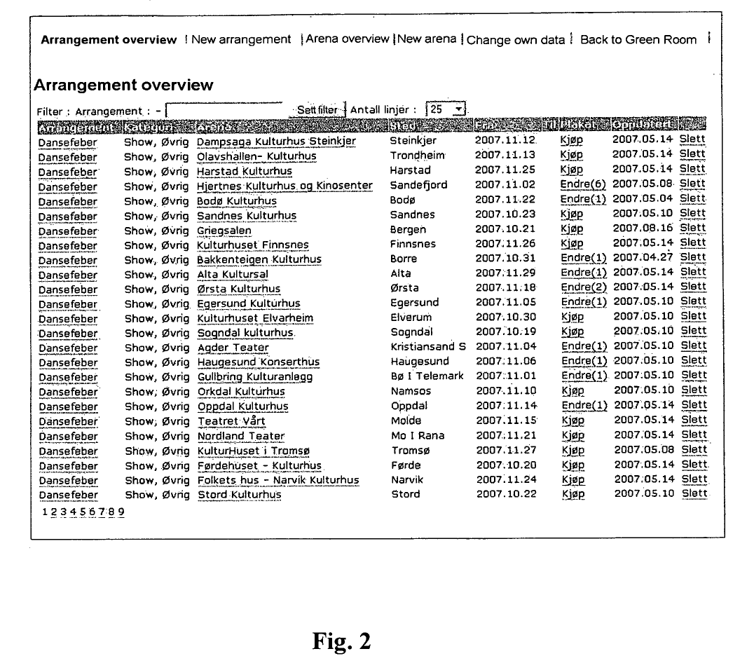

The Organizer is among others given the choice of choosing a view of own arrangements. If an organizer chooses to display own arrangements a display of all his arrangement will be shown with column and rows (FIG. 2). One row will typically comprise a name of an event, a category for the event, a name of an arena, geographical location, time period for the event (start and stop date), last update of the row and a column that gives the organizer an opportunity to buy posters (plakat) that will be shown to consumers. If a number of rows are displayed then the organizer may sort events according to preferred dates, areas, arenas etc. in the same manner that is familiar for spreadsheets.

If an organizer clicks on an arrangement he will be forwarded to a completed fill in form in which he may alter information. He is however only allowed access to own events.

If an organizer clicks on an arena column he will be directed to a completed tally sheet in which he may change information.

In the column dedicated for purchase of posters a status will indicate a state, such as one of the three states, Buy (Kjøp), Change (endre) and Show (vis). Click on Buy will direct the organizer to a poster tree structure. If the wording Change is displayed on a row it indicates that the organizer already have visited the poster tree structure but has not confirmed purchase of announcements. A click on Change directs the organizer to the poster tree structure. Show (Vis), indicates that the organizer has purchased a poster advertisement a click on this field direct the organizer to an overview of posters.

### Ordering Poster Advertisements

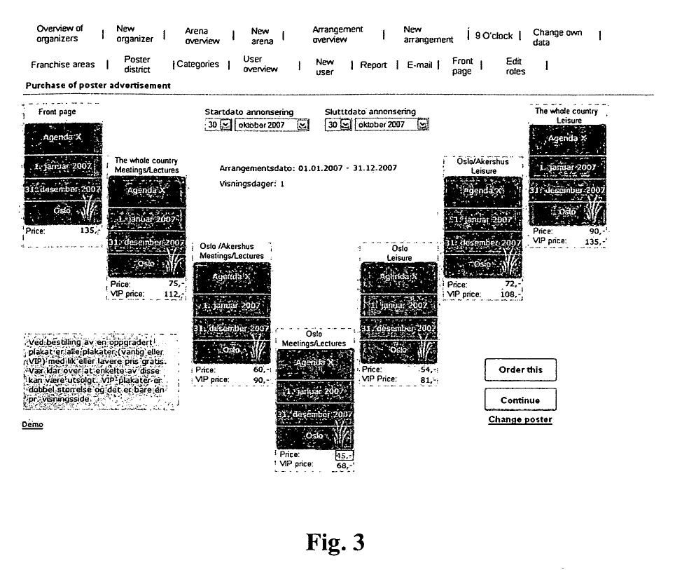

The poster tree structure referred to above calls for an explanation. Access to the poster tree structure (FIG. 3) is either through the column dedicated for purchase of posters described in the previous section or one will be directed to this option after registration of an event. The following items summarize the available posters that may be ordered.
At the bottom of a “tree structure” you will find the basis poster, this is the poster which gives the organizer least exposure. This poster is restricted to type of activity and to the most fine-meshed geographical area. You will have two choices for this poster either an ordinary poster with the mentioned restrictions or a VIP poster with the same restrictions.
In the next level the tree is divided into a left and right branch, one step up in the right branch gives one level up in a “what” category, i.e. less fine meshed filter for “what” category. One step up in the left branch indicates a bigger area, i.e. an area with more consumers and hence better exposure. In the second level you are also invited to pay extra for VIP posters.
The following levels follow the layout of level two by being divided into a right and left branch. Level three on the right side has reached a top level of category “What” hence this level and subsequent levels gives exposure in wider geographical regions, whereas the left branch level three uses the same “What” category as previous left branch levels but includes a geographical area with a higher population than the previous.
Typically a higher level has precedence over a lower level, hence for example paying for level “two” will include exposure according to level one.
The price for a poster is as indicated above the subject of its level of What category and its geographical exposure. To further make the structure of pricing realistic a system that categorizes geographical areas according to their population may be used. According to one embodiment of the present invention an area with a large population will be more expensive than one with a smaller population. A system that separates population into classes starting with a basic area which is given a factor 1. This indicates that the price of a poster for a basic area will not have any extra cost based on geographical area. However if an organizer wants a poster to be exposed for more people he will have to pay the basic price multiplied with a factor, where the size of the factor is dependent of the size of the population in for a chosen area. The highest factor will include the whole area covered by the provider of the search facility according to the present invention.
It is obvious that some cultural events address a wider audience than others, according to one embodiment of the inventions this is covered by a system that differentiates different “what” categories. For example Rock may address a wider audience than for instance “World Music” hence an organizer of Rock events is likely to be willing to pay more for a poster than an organizer of a “World music” event. Different “What” categories and sub categories are given factors that will be multiplied with a basic price.
According to the two previous items it should be clear that the price structure of a poster is a mix of “What” category and the population of the area of interest. Giving the following equation:
   Poster price=Basic Price*Population factor*What factor
VIP posters may be given an extra factor that is to be further multiplied.

### Poster Module

In the section above it was described how to order posters, and some of the logic related to pricing of posters was described. However the poster module handles more than pricing, it also comprises a poster engine (plakatmotor). The front page of a portal that provides a system and method for event search according to the present invention will contain posters were organizers and event providers can advertise events which a consumer is likely to be interested in. This section defines the rules governing how posters shall be displayed and which posters to display.

Definitions, wordings and expressions which may have a several meanings are explained in the following table:

| Expressions | | Description | | Example(s) | |
|---|---|---|---|---|---|
| Main category | | The highest level within the | | Concert, Show, Theatre, | |
| | | “What” categories | | Festival | |
| Sub category | | The lowest level within the | | Rock, Pop, Hip-Hop (under | |
| | | “What” categories | | Concert main category) | |
| Category | | A particular category may be | | Concert, Restaurant, | |
| | | a main category or a sub | | Dance band | |
| | | category | | | |
| District | | The local area consisting of | | | |
| | | specific | | | |
| | | township/municipality and zip | | | |
| | | codes. These districts maybe | | | |
| | | defined in cooperation with | | | |
| | | franchisee | | | |
| Area | | Generic term for existing | | District, county, region, | |
| | | defined areas. | | province, the whole | |
| | | | | country | |
| Poster tree | | The user interface for poster | | | |
| structure | | sale. Displays the posters in | | | |
| | | level/area combinations | | | |
| | | which is available for | | | |
| | | purchase | | | |
| Publication | | The date and time a an | | A particular date and time | |
| date | | event is available to | | | |
| | | franchisee and normal users | | | |
| | | of the system according to | | | |
| | | the present invention | | | |
| Menu | | A search post that according | | | |
| | | to one embodiment is found | | | |
| | | on the left side of the front | | | |
| | | page of the search facility | | | |
| | | according to the present | | | |
| | | invention | | | |
| Modal | | Indicates that a window | | Normal behavior for “open | |
| | | always will be in front of an | | file” dialog box in Microsoft | |
| | | underlying window as long | | Word | |
| | | as the modal window is | | | |
| | | displayed. | | | |
| Type | Standard | Width | 130 pixels | Height | 173 pixels |
| of | VIP | | 173 pixels | | 230 pixels |
| poster | | | | | |

The posters are preferably of two types, a standard type and a VIP type, the defined size in the last row of the table above are examples and they may be varied according to use of device and/or market.

Organizers are given the possibility to upload pictures for the posters. These pictures will be stored as original-, standard- and VIP in a data base. The storing is executed without any influence from the organizers.

A prerequisite for pictures can be that the aspect ratio is 3:4 and that the height and width of the original is at least as large as a VIP poster.

The system provides posters with text versions so as to ensure meaningful posters where organizers haven't uploaded pictures. The text version is adapted to be displayed on top of the poster picture. Preferably, a version of the text poster will be provided for each combination of district and category relevant for an event. Each of these versions should preferably be possible to edit separately.

The text version of the posters may comprise the following texts:

| | Standard placing | |
|---|---|---|
| Text | (center) | Description |
| Title | #1 | Generated from the title of the event. |
| Arena | #2 | Generated from name of arena from the |
| | | current poster arrangement |
| | | (plakatarrangement) |
| StartDate | #3 | The first date for an event in a poster area, |
| | | (possibly a number of arenas) |
| EndDate | #4 | Last date for an event in a poster area, |
| | | (possibly a number of arenas) |

A poster may be sold within the following predefined areas (an example):

| Area | Description |
|---|---|
| District | Equivalent to a self-defined district under a county (province) |
| County | County (province) |
| Country | Country, and in some jurisdictions states (e.g. USA). |
| Region | A number of countries (e.g. EU) or states (e.g. USA) |

It is obvious that the divisions of predefined areas must be adapted to local situations, dependent on population density, and a country or regions' divisions. Small independent countries may need a very different classification than a large country divided into states or a number of countries that is part of a reciprocal trade agreement.

Sale of posters may be regulated by rules; these rules may regulate the number of posters that can be sold within an area, within a category or within a time period. Some examples of rules is listed in the items below:
Posters may only be traded for events registered in the system according to the present invention.
When selling posters a poster for the “home” district always have to be sold.
For each day it will only be available 10 posters, or the numbers of posters needed to fill the poster area of the entrance page of the search facility according to the present invention, for each area level within each category. When all available posters for a particular day within a particular level have been sold, no more posters may be sold for that day.
A poster may be sold on higher levels than district and sub-categories if there are vacant spots for posters.
A poster should be sold for all levels up to the highest required level; hence one may not “skip” levels within the poster tree structure.
Posters are sold for a fixed period of time, at least for one day.
A poster cannot be displayed on dates after the final date for an advertised event.
If posters are available for short periods on higher levels in the poster tree structure than chosen period for a basic poster one may purchase posters for short periods.
A basic poster must have the same or longer display period than posters on higher levels, I.e. no posters may be sold outside the display period of the basic poster.
Posters may not be sold for dates before date of publication.
Organizers may extend display time for a poster if an event is extended provided there are vacant poster spots.
An event may be displayed within a number of sub-categories and main categories. Posters may be sold for all basic levels where the event belongs and upward in the poster tree structure.
Organizers and event providers cannot purchase two or more identical posters within levels having the same name.

The following rules may apply for sale of VIP posters:
Only one VIP poster may be sold per category and area combination.
VIP poster can only be sold when posters within the same category/area is already sold.
VIP posters may have shorter display time than corresponding posters within same category and area.
Display times of posters in a particular category and area prevails display times of a VIP poster.

To ensure that the entrance portal according to the present search system and method always displays a number of posters identical to the numbers of posters available on the entrance portal one may adopt rules that ensure that all available spots are occupied.

Districts are defined using information such as ZIP numbers.

When the front page of the portal according to the present invention is accessed posters will not be displayed promptly, a predefined period of time such as 2 seconds will leave the poster screen areas empty. The first posters displayed before the user starts to maneuver on the portal will be VIP posters for each main category for the country or for a “large” poster district area.

Posters may be faded in when they are ready to be displayed.

If selections have been made and the cursor is not over a menu choice posters for all chosen “What” “Where” combinations will be displayed. 10 and 10 posters will be displayed for a preset time interval such as 5 seconds for each combination. The number “10” is a matter of design choice and may be changed according to the service providers request or according to the chosen display device (Computer, television, Cell Phone, PDA, Smart phone etc.).

Display of posters may also be influenced by mouse pointer movements, if the cursor is moved within a geographical map the posters will be displayed according to “Where” criterions (as well as What and When criterions if chosen).

A number of other rules may be adopted so as to further ensure that posters are displayed in a meaningful way. Rules may for example be as; VIP posters prevail “normal” posters, “longest living” posters may prevail “shorter living” posters, higher levels prevails lower levels etc.

If a consumer hits an event that fits perfectly to his choice(s) the corresponding posters may be shown highlighted or with a surrounding frame that visualizes relevance.

Downloading of posters will follow sudden rules, such as first download VIP posters then highlighted/relevant posters and finally normal posters (the remaining posters that fulfill requirements to be displayed). Further there must be implemented rules that take into account the download speed to particular users. If a cursor move fast over the screen it will be meaningless to display posters according to fast movements by cursors, hence there must be time limits that governs downloading of posters when a cursor is moved over a screen.

### Franchise and Call Center Users

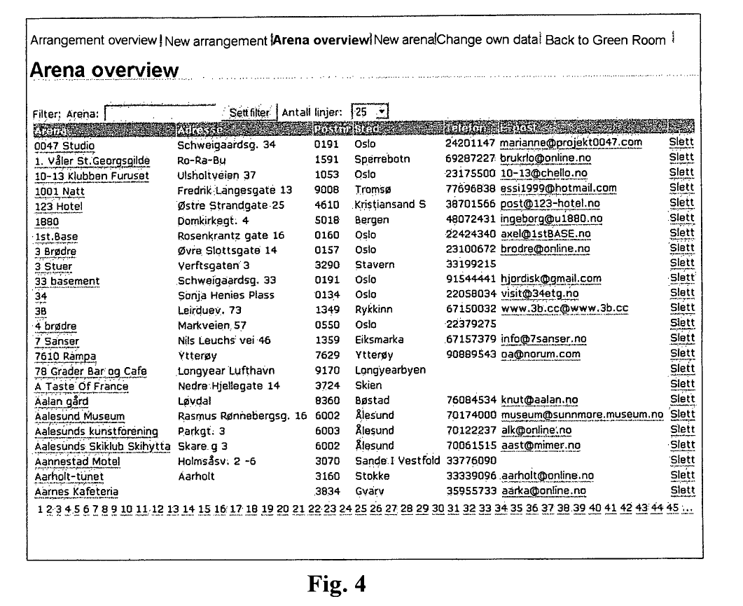

Franchisees and call center users have access to functionality that are not available to organizers' the added functionality includes a display option that displays an overview of event organizers (FIG. 4).

Franchisees and call center users may modify information on the list of organizers and even delete organizers. A deleted organizer will however still be displayed for an Admin User, the Admin User will however be informed by the action from the franchisee or the call center user by a displayed trash can, the Admin User may restore the organizer or delete the organizer.

Franchisees and call center users may add organizers to the list of organizers.

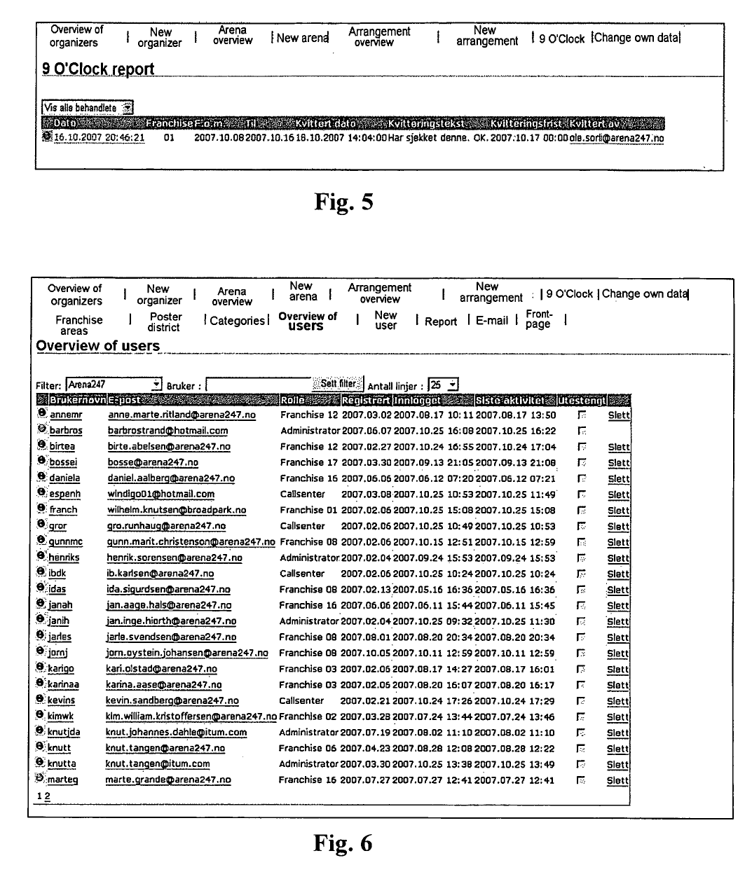

In one embodiment of the present invention a report (FIG. 5) will be forwarded to all franchisees, the report will display all changes from the previous day within the franchisees' area. The franchisee will preferably acknowledge that they have received and looked over the report.

The franchise and call center users have all the privileges of the organizer in addition to those indicated above.

### Admin User

The Admin user has the same privileges as the Franchisees and call center users and some additional privileges.

The Admin User will have access to all reports sent to franchisees and call center users. Furthermore, as indicated in the previous section, the Admin User may review deletions carried out by franchisees and call center users.

The Admin user may also define franchise areas, hence the areas that are to be covered by each franchisee.

The Admin User may also add new poster areas to the system. A poster area controls the display of poster announcements dependent on a users (consumers) choice in the “Where” menu. A poster area may be added starting with an already defined area such as a county, province or region thereafter the Admin User enters an appropriate name for the new poster area.

The Admin User may also change existing poster areas or even delete poster areas.

Admin Users may also revise the “What” categories; the categories are organized in a tree structure with main categories and subcategories. Furthermore, the Admin Users may also revise the factors that differentiate the poster prices.

Admin Users may further be provided with an overview of all users logged onto the system (FIG. 6). The Admin User may delete users, revise their role, and add users, block users, unblock users and search for users.

The search according to the present invention facilitates search for cultural events by introducing a hierarchical principle that is very intuitive for a user, firstly the user will choose a “what” category. The idea behind this is that a user will normally have a clear idea of what he/she wants to see/do or participate in. The search facility is very loyal to the “what” category hence leaving out events that are within other activities than searched for. For the user this means that he/she don't have to filter out a lot of unnecessary information. In addition to facilitate search by “what” category the method and system according to the present invention also provides a direct search method, where the user simply enters a name of an artist, arena or any other suitable keyword. The latter solution may be suitable if the user is well informed on forehand and knows what he wants. The beauty of the first method is among others its versatility simply choose what and a number of dedicated ads, posters, within this “what” category will be shown, thereafter choose where and the posters will be updated according to firstly a what criterion thereafter a where criterion. Finally choose a date for a selected event or for a number of events according to what and where, and a list of appropriate events will be displayed.

The method and system according to the present invention is relevant in other contexts than the one described here. The following is, however, an example of a function and purpose of the present invention.

DTA, the search system and method according to the present invention, is a portal, such as an Internet portal where users easily can find what they seek of events within culture, sports and other areas.

The registration of events is being undertaken by a franchise network of professional agents. Registration may be for free. The same network sells poster-ads to the search portal. The business of trading posters, sales rules, display rules etc are dealt with in the previous sections.

In the following it is disclosed a short example of the search facility on an Internet Portal according to one embodiment of the invention.

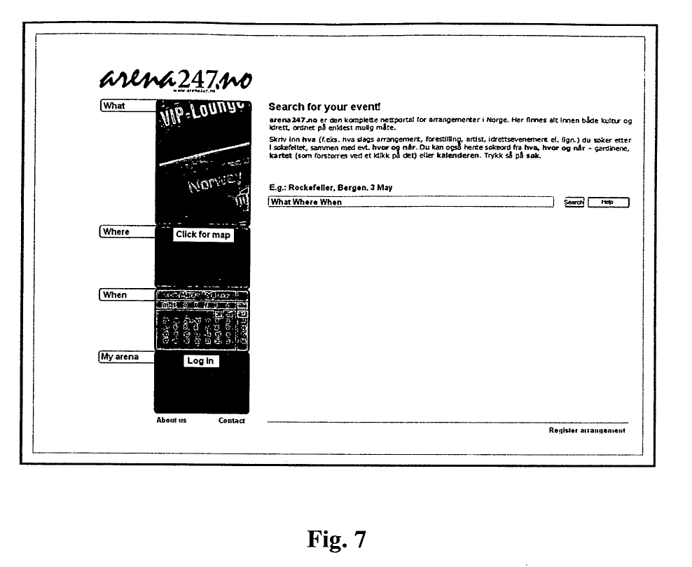

All searches and all activation of the search facility (DTA) takes place on a front page (FIG. 7).

Search for events are done by using the following criteria:
What (event, according to categories or sub-categories)
Where (location, according to categories, sub-categories or map)
When (time or period, according to menu or calendar)

Whilst all the choices (in What, Where or When) influence the search result, the When menu and calendar does not influence the posters.

All advertising takes place in poster form in a separate section. This section may consist of 10 changeable posters (5 horizontally, 2 vertically). It should be noted that the layout described is a matter of design and other configurations are within the scope of protection.

The 10 posters displayed changes in correspondence with the chosen search criteria and the curser's position in menus and map. If nothing has been chosen in a menu, the posters displayed will correspond to all categories listed in that menu.

For each poster there is a Hold button, so that the user can keep this poster visible, while carrying out the desired search operation.

Over each poster is a headline text, identifying the actual event.

In addition to the 10 posters there is a VIP poster, at all times displaying a search-related event. Advertisers will pay extra for such a VIP poster, as they will for any upgrading (see below).

If less than 10 posters match a search criteria, other posters will be displayed, according to relevant geographical location and total advertising time. The posters that exactly match the search will have a more visible frame, while the others will have a less visible frame.

In addition to the ground-level local poster (sub-category What; sub-category Where), an advertiser can upgrade his poster placement, so that the poster is displayed either as the only one in its sub-category in a larger geographical area, or as the only one in its main category locally.

Complicated software is developed, which manages the selection, priorities and upgrading of posters, with the “Hold” possibility also taken into consideration.

In one embodiment the hierarchical search categories is divided into the following categories, however it shall be appreciated that many other hierarchical category divisions are possible dependent for example on the size of market that is served.

The search possibilities according to the present method and system are divided as follows:

1. What: 10 main categories; 60 sub-categories.
2. Where: 24 main categories; 120 sub-categories

Number of possible upgrade posters:

1. 10 posters for no selection What; no selection Where

2. 60 posters for main category What; no selection Where

3. 600 posters for sub-category What; no selection Where

4. 1440 posters for sub-category What; main category Where

5. 240 posters for no selection What; main category Where

6. 1200 posters for no selection What; sub-category Where

7. 12000 posters for main category What, sub-category Where

Number of possible VIP-posters: 7200

Number of possible posters on “ground level”: 72000

(sub-category What; sub-category Where)

This last number requires 10 posters for every sub-category for every town, and of course only constitutes a potential, as many towns are too small to have 10 posters in each sub-category.

The method of Directly Targeted Advertisements (DTA) according to the present invention renders possible a very competitive pricing of ads.

### DESCRIPTION OF SEARCH ON A PORTAL ACCORDING TO THE PRESENT INVENTION

All searches take place on the front page of the portal. In the following an example of a search according to one embodiment of the present invention is disclosed with reference to the accompanied drawings 1-6. It is to be noted that the design of the referenced pages is a matter of design choice and can thus be altered according to the whish of the service provider. Furthermore, the number of posters used in the poster field is chosen to be 10, this is also a matter of design choice and any other convenient number may be chosen within the scope of the present invention.

The posters change continuously according to cursor's position in the different menus.

With reference to FIG. 7 “What Where When” is written in the search field, after a short search period posters are faded into the poster field, in this particular example 10 posters are faded into the poster field.

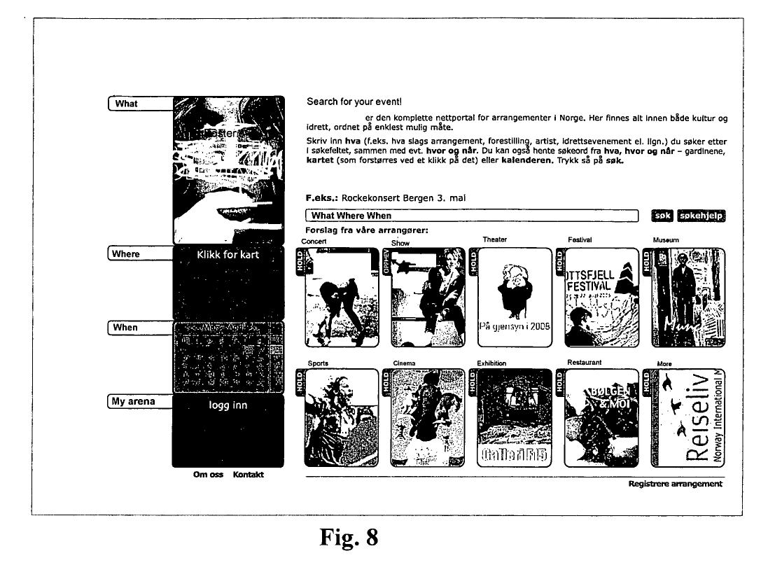

Now with reference to FIG. 8, 10 posters with category heading have appeared in the poster field and a general VIP poster has appeared in a VIP field. The user has marked the second leftmost poster in the first row, indicated by the wording “opphev” (Cancel) appearing at the upper left corner of said poster. Cursor is on Hold button (for Show), which have changed to “Opphev” (cancel)

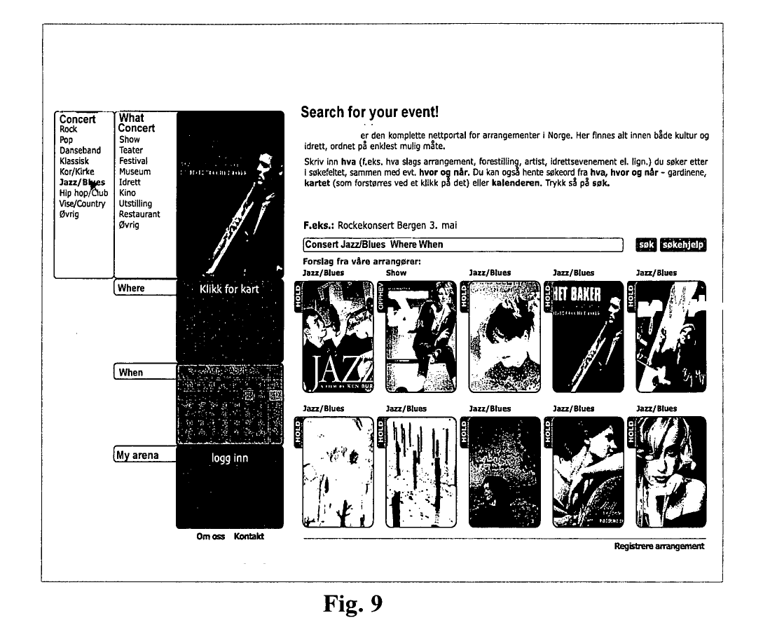

Still referring to the accompanied figures now with reference to FIG. 9 the user has started a search and has chosen Jazz/Blues concert as a what category.

Cursor has, via what and Konsert (concert) stopped on Jazz/Blues in the What menu. Konsert (concert) is marked in What main menu and Jazz/Blues is marked in What sub-menu. A VIP poster for Konsert (concert) Jazz/Blues is shown in the VIP field.

Konsert (concert) Jazz/Blues is written in bold in search field and 9 Jazz/Blues posters are shown, in addition to the poster that was held (marked out in the previous step).

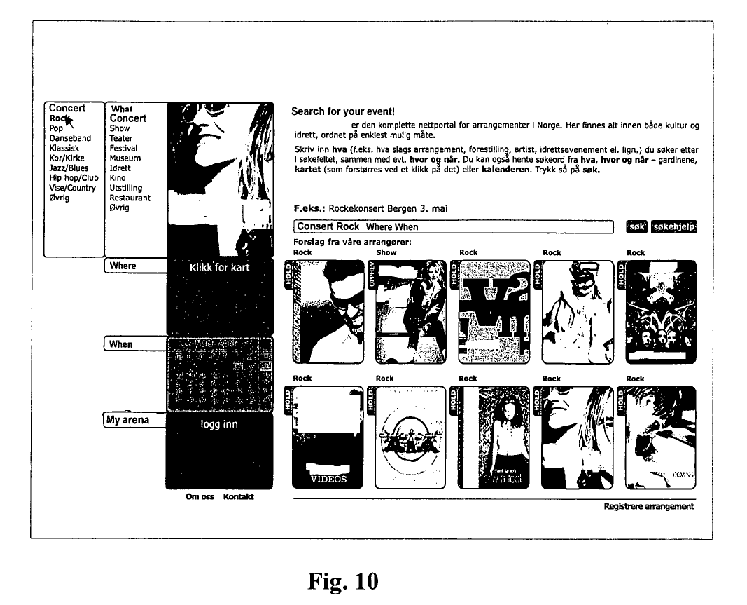

In FIG. 10 the user has left the Jazz/Blues search, and instead searches for Rock and the cursor have moved from Jazz/Blues to Rock in What sub-menu.

Konsert (concert) is marked in What main menu and Rock is marked in What sub-menu. A VIP poster for Konsert (concert) Rock is shown in the VIP field.

Konsert Rock is written in bold in a search field and 9 Rock posters are shown, in addition to the previously marked poster.

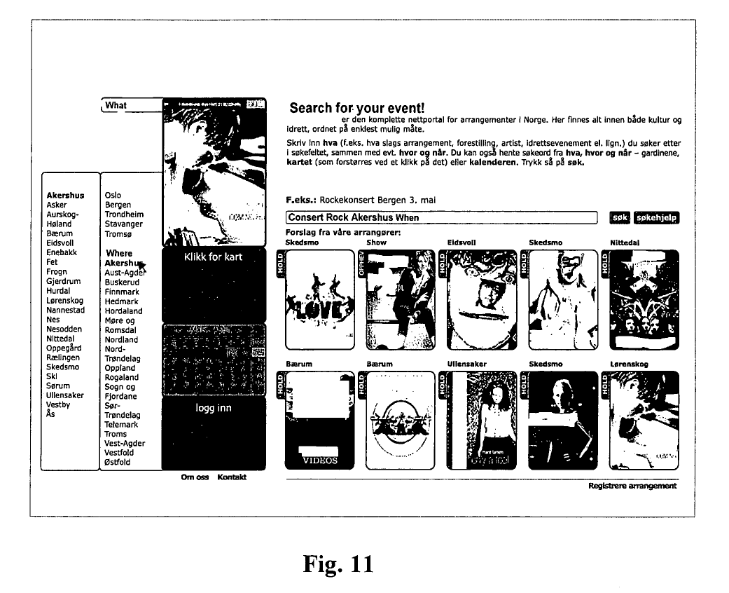

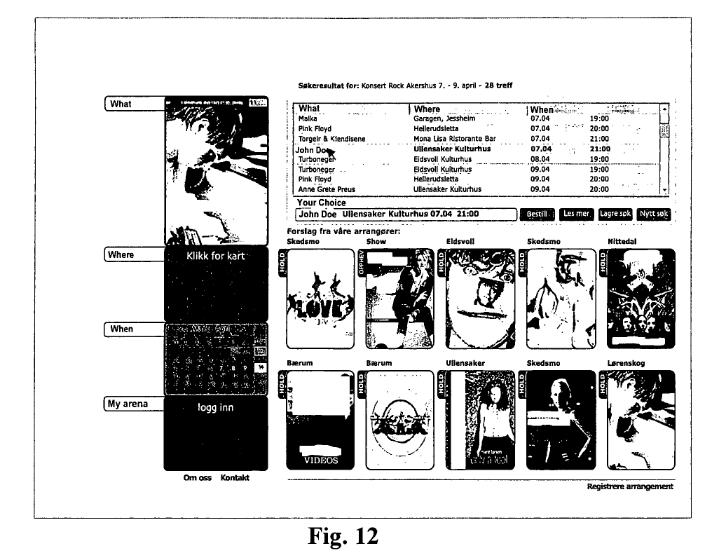

In FIG. 11 the User has ended What search, and has chosen a geographical area (Akershus) under Where. The Cursor is now on Akershus (Geographical area), which is now marked, in Where main menu. A VIP poster for Konsert (concert) Rock Akershus is shown in the VIP field and Konsert Rock Akershus is written in bold in the search field. 9 Rock posters from Akershus are shown, in addition to the previously marked poster.

Now with reference to FIG. 12, the User has selected the period 7.-9. April in the calendar, has pushed the Søk (Search) button, and has chosen John Doe's concert at Ullensaker Kulturhus. Listing of search results is shown, indicating number of matches.

Cursor is on John Doe, which is marked, in the search results listing and the dates 7, 8 and 9 of April are marked in the calendar.

A VIP poster for Konsert Rock Akershus is shown in the VIP field and Konsert Rock Akershus is written in bold in the search field.

Finally 9 Rock posters from Akershus are shown, in addition to the previously chosen one.

What is claimed is:

1. A system that provides for online search of events using electronic devices where the system comprises;
a portal page,
a poster tree structure, and
a search engine configured to search events using what functionality, where functionality and when functionality.

2. A method that provides online search of events using electronic devices where the method comprises the step of;
opening a portal page configured to search events,
moving a pointer or cursor to a what main category,
optionally moving the cursor or pointer to a what sub-category, choosing a what main category or what sub-category
moving the cursor or pointer to a where field, choosing a geographical area of interest, and
moving the cursor or pointer to a when field and choosing an event date.
